(19) United States
(12) Patent Application Publication
(10) Pub. No.: US 2016/0123511 A1
(43) Pub. Date: May 5, 2016

(54) DUCT ASSEMBLY WITH A CONNECTOR

(71) Applicant: FORD GLOBAL TECHNOLOGIES, LLC, Dearborn, MI (US)

(72) Inventors: Jibran Ali KHAN, Dagenham (GB); Robert Andrew LEESON, Stansted (GB); Simon POTTICARY, Basildon (GB); Darren John WOOD, Canvey Island (GB)

(21) Appl. No.: 14/932,451

(22) Filed: Nov. 4, 2015

(30) Foreign Application Priority Data
Nov. 4, 2014 (GB) 1419661.2

(51) Int. Cl. F16L 37/248; F16L 23/12; F16L 23/00

(52) U.S. Cl. CPC F16L 37/248; F16L 23/003; F16L 23/12

(57) ABSTRACT

A duct assembly comprises a first duct. The duct assembly may further include a first connector and a second connector. The first connector is integral to the first duct of the duct assembly. In an embodiment, the first connector is adapted to form a detachable coupling with the second connector.

### CROSS-REFERENCE TO RELATED APPLICATIONS

This application claims foreign priority benefits under 35 U.S.C. § 119(a)-(d) to GB 1419661.2 filed Nov. 4, 2014, which is hereby incorporated by reference in its entirety.

### TECHNICAL FIELD

The present disclosure relates to a duct assembly for connecting a duct between two components of a system.

### BACKGROUND

Conventionally, ducts are used for transfer of fluids from one component to another component in a particular system. For example, in HVAC systems conventional ducts may be used to transfer a refrigerant from an evaporator component to a condenser component, or in an air-intake system for IC engines, to transfer air from an air-filter component to a turbocharger component.

One such prior art system is described in the U.S. Pat. No. 7,832,775 ('775 patent). As per FIG. 1, the '775 patent describes a connector connecting mutual ends of a first plastic duct and a second plastic duct. The first plastic duct is an air guide element 3 and the second plastic duct is a tubular nipple 2 which is disposed on a turbocharger housing. The connector described in the '775 patent is a bayonet ring type connector, i.e., the bayonet ring 12 as shown in the FIG. 1. As can be seen in FIG. 1, the bayonet ring 12 is an independent coupling device which connects the tubular nipple 2 and the air guide element 3. The connection between the air guide element 3 and the tubular nipple 2 is facilitated by one or more projection segments 8. The projection segments 8 are provided on the outer circumference of the air guide element 3.

Furthermore, similar projection segments 16 are provided on the outer circumference of the tubular nipple 2. The bayonet ring 12 is provided with projection segments 14, 15 projecting inwards on the first end and the second end of the bayonet ring 12. To form the connection, the first end of the bayonet ring 12 is aligned with the air guide element 3, and the projection segments 8 on the air guide element 3 are interlocked with the inward projection segments 14 on the first end of the bayonet ring 12. Similarly, a second end of the bayonet ring 12 is aligned with the tubular nipple 2, and the projection segments 16 on the tubular nipple 2 are interlocked with the inward projection segments 15 on the second end of the bayonet ring 12. In this manner, the bayonet ring 12 is used to form a connection between the two plastic ducts.

Considering the prior art system as described above, it was determined that the bayonet ring 12 would occupy stack-up length, which is the length occupied by the bayonet ring 12 in the assembled condition. For example, the bayonet ring 12 when fixed to the duct ends occupies some length of the duct. Therefore, in systems where it is advantageous that the length occupied by the connector on the duct for connecting the two components should be less, such conventional connectors may not be applicable. Further, in the prior art system, the diameter of the bayonet ring 12 is also larger than the duct thereby causing an increase in effective diameter of the duct over a stack-up length, that is, equal to the length of the bayonet ring.

Further, the projection segments formed on the air guide element 3 and the tubular nipple 2 and on the inside of the bayonet ring 12 are formed from rigid materials. Thus, the use of the bayonet ring 12 is limited to ducts made from a rigid material and is not suitable for connecting the ducts made from flexible material.

In some applications, convolutes may be provided on the duct. Convolutes, as would be generally understood, provide flexibility to the ducts. For example, conventionally convolutes have been used on the ducts to absorb vibrations that may be produced during operation. However, it was also determined that providing an adequate number of such convolutes may result in the utilization of much of the effective length of the duct leaving less length for accommodating the connector. Also the assembly requires more core components. For example, the duct assembly of the '775 patent system comprises the tubular nipple 2, a bayonet ring 12, and an air-guide element 3. As such there are three components in the conventional duct assembly disclosed in the '775 patent.

### SUMMARY

The subject matter described herein relates to a duct assembly. The duct assembly includes a first duct and a first connector. The first connector is integral to the duct assembly and is adapted to form a detachable coupling with a second connector. In an embodiment, the first connector further includes at least one bayonet tab for connecting with the second connector. The second connector may further be provided with at least one slot to receive the at least one bayonet tab of the first connector. Since the first connector is integral with the first duct, the connection length is significantly reduced. Therefore, the duct assembly disclosed in the present subject matter is simple and also suitable for connecting the components in systems where the connectors should occupy less length on the duct.

In the duct assembly as per an embodiment disclosed herein, the second connector is directly mounted onto a component for connecting the duct assembly to the component. Thus, a use of a separate duct for connecting the second connector to the component to which the fluid is to be supplied may be avoided. Therefore, the effective length of the duct assembly is significantly reduced. Further, the number of components is also reduced, thereby reducing the complexity of construction as compared to the prior art duct assembly. Further, as per a disclosed embodiment, the stack-up length of the first connector is also comparatively less.

Different features, aspects, and advantages of the present subject matter will be better understood with reference to the following description and the appended claims. The summary is provided to introduce a selection of concepts in a simplified form and is not intended to identify key features or essential features of the claimed subject matter, nor is it intended to be used to limit the scope of the claimed subject matter.

### BRIEF DESCRIPTION OF THE DRAWINGS

FIG. 1 illustrates an exploded view of a prior art duct assembly including a bayonet connector.

FIG. 2A is a perspective view of a duct assembly according to a disclosed embodiment.

FIG. 2B is a sectional view of the duct assembly, according to a disclosed embodiment.

FIG. 2C is a close up perspective view of the duct assembly illustrating the 0-ring seal, according to a disclosed embodiment.

FIG. 3 is a perspective view of the first connector of the duct assembly, according to a disclosed embodiment.

FIG. 4 is a perspective view of the second connector of the duct assembly, according to a disclosed embodiment.

FIG. 5 is a perspective view illustrating the ramped feature of a bayonet tab, according to a disclosed embodiment.

FIG. 6 is a perspective view of the bayonet mechanism without a duct for illustrating a screw fastening mechanism, according to a disclosed embodiment.

FIG. 7 is a perspective view of the fastener clip assembly, according to the present subject matter.

FIG. 8 is a sectional view illustrating another example of the duct assembly, according to a disclosed embodiment.

FIG. 9 illustrates the duct assembly with integrated radial seal in a duct system, according to a disclosed embodiment.

FIG. 10 illustrates the duct assembly with a separate radial seal in a duct system, according to a disclosed embodiment.

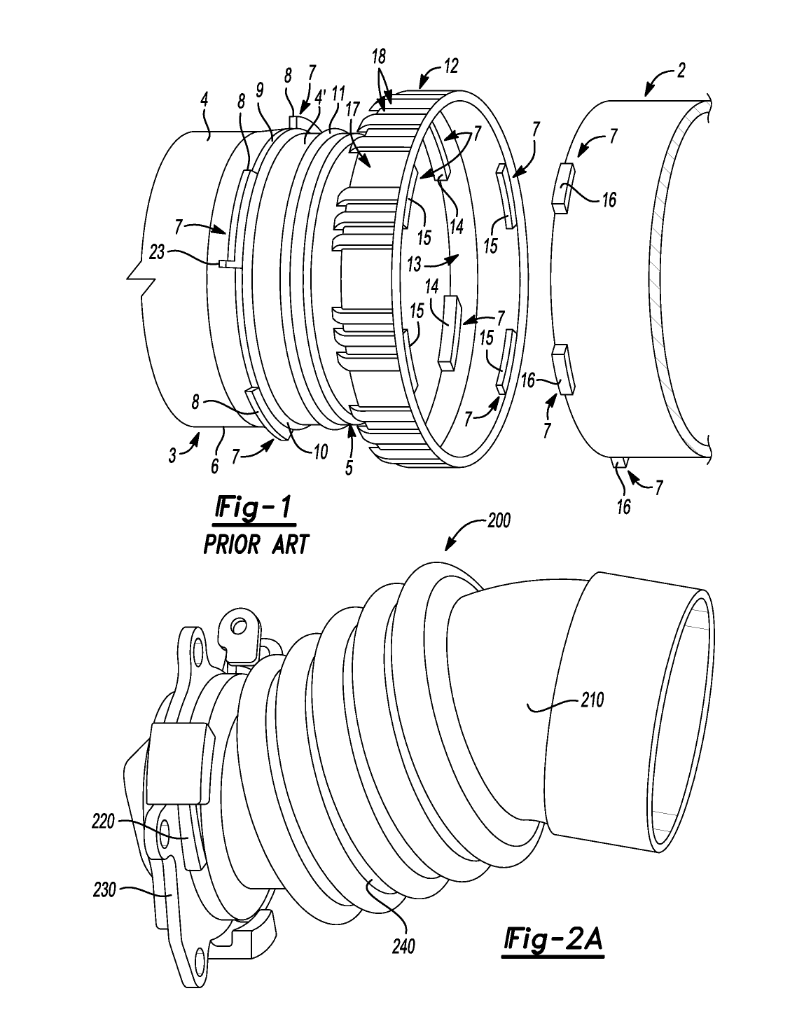

### DETAILED DESCRIPTION

As required, detailed embodiments of the present invention are disclosed herein; however, it is to be understood that the disclosed embodiments are merely exemplary of the invention that may be embodied in various and alternative forms. The Figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

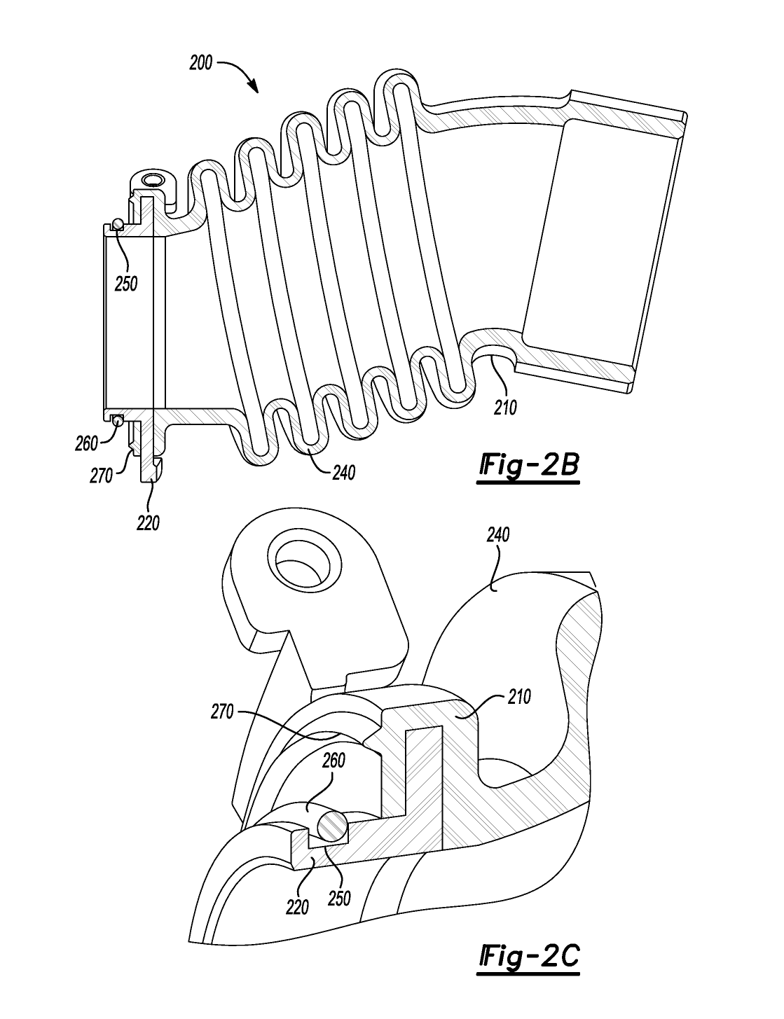

FIG. 2A and 2B illustrate a perspective view and a sectional view, respectively, of a duct assembly 200 according to an embodiment of the present subject matter. The duct assembly 200 comprises a first duct 210 having a first end and a second end, and a connector assembly. The connector assembly further comprises a first connector 220 and a second connector 230. It would be understood that the duct assembly 200 may be used to transfer fluids between two components in a system. The first connector 220 may have a first end and a second end. The first end of the first connector 220 is integrated with the first end of the first duct 210, and the second end of the first duct 210 may be mounted on a first component of the system. In one example, the second connector 230 may be mounted directly onto a second component of the system. In a second example, the second connector 230 may be integrated with a first end of a second duct and a second end of the second duct may be mounted onto the second component.

Continuing with the duct assembly 200 as illustrated in FIG. 2A and FIG. 2B, the first connector 220 and the second connector 230 may further include at least one coupling means for detachable engagement with one another. In one embodiment, the first connector 220 and the second connector 230 may be detachably coupled by a bayonet-type mechanism, such as a bayonet connector.

The integration of the first connector 220 and the first duct 210 may be affected at the manufacturing stage. For example, the first duct 210 may be formed by over-molding the duct material onto the first connector 220 at the time of manufacturing. The manufacturing process may include manufacturing of the first connector 220 independently through a separate manufacturing process. The process for manufacturing the first connector 220 may be based on conventionally known techniques and processes.

For the purposes of explanation, FIG. 2C is provided to illustrate a magnified perspective view of the first connector 220. As illustrated in FIG. 2C, the cross-section of the first connector 220 may have an ‘L-shaped’ profile having a first portion and a second portion. However, as would be understood by a person skilled in the art, the cross-section of the first connector 220 is be limited to an L-shaped profile and may be of different shapes. The first portion of the first connector 220 may be extending along the axis of the first connector 220, and the second portion of the first connector 220 may be extending in a radially outward direction. During the manufacturing process, the first duct 210 may be formed by an over-molding process. As an example of the present subject matter, the molding may be implemented such that first duct 210 may be formed over and around the second portion of the first connector 220. Thus, after the over molding, the first connector 220 and the first duct 210 are integrated. Besides over-molding, any other method of integrating the first connector 220 with the first duct 210 may be used without deviating from the scope of the present subject matter. For example, chemical bonding, fastening, clamping, and so on.

In an embodiment, the first duct 210 may further include a plurality of convolutes 240. The plurality of convolutes 240 provide flexibility to the first duct 210 and thereby enable the first duct 210 to withstand vibrations. Although the embodiments as discussed have been described in conjunction with the first duct 210 having the plurality of convolutes 240, other embodiments of the first duct 210 without the plurality of convolutes 240 would also fall within the scope of the present subject matter.

As illustrated in FIG. 2C, after the over molding of the first duct 210 onto the first connector, the second portion of the first connector 220 may be covered with the first duct 210, and the first portion may not be covered with the first duct 210 and therefore may extend axially beyond the first duct 210.

In an embodiment, the first portion of the first connector 220 which is exposed outside the first duct 210 may be further provided with a radial groove 250 formed in its outer circumferential surface. The radial groove 250 may be further provided with a radial seal 260 (as depicted in FIG. 2C). The number, the type, and the profile of the radial seal 260 may vary according to the application requirements. Depending upon the application requirements, the radial seal 260 may be an O-ring, D-ring, flat gasket, X-ring, and the like. The radial seal 260 provides sealing between the first connector 220 and the second connector 230 so that the fluid that is being transferred through the first duct 210 is not leaked out of the duct assembly 200. Although FIG. 2C depicts a single radial groove 250, multiple radial grooves would also be within the scope of the present subject matter.

In an engaged condition, the first connector 220 is coupled with the second connector 230, as can be seen in FIG. 2A. In such a condition, the portion of the first duct 210 enclosing the second portion of the first connector 220 may be in direct contact with the second connector 230. The surface of the first duct 210 which is in contact with the second connector 230 may be understood to be an engaging surface. An axial seal 270 (see FIGS. 2B, 2C) may be incorporated into the first duct 210 on the engaging surface. The axial seal 270 reduces the friction between the first connector 220 and the second connector 230 by reducing the contact area on the engaging surface between the two connectors, i.e., the first connector 220 and the second connector 230. The axial seal 270 also provides a preload between the first connector 220 and the second connector 230 thereby forming a strong bayonet coupling.

As can be seen from FIG. 2A, the diameter of the first connector 220 may be larger than the diameter of the first duct 210 but the first connector 220 occupies less length of the first duct 210 as compared to the conventional connectors. Therefore, the features of the first connector 220 in the integrated state facilitates in reducing the stack-up length occupied by the first connector 220.

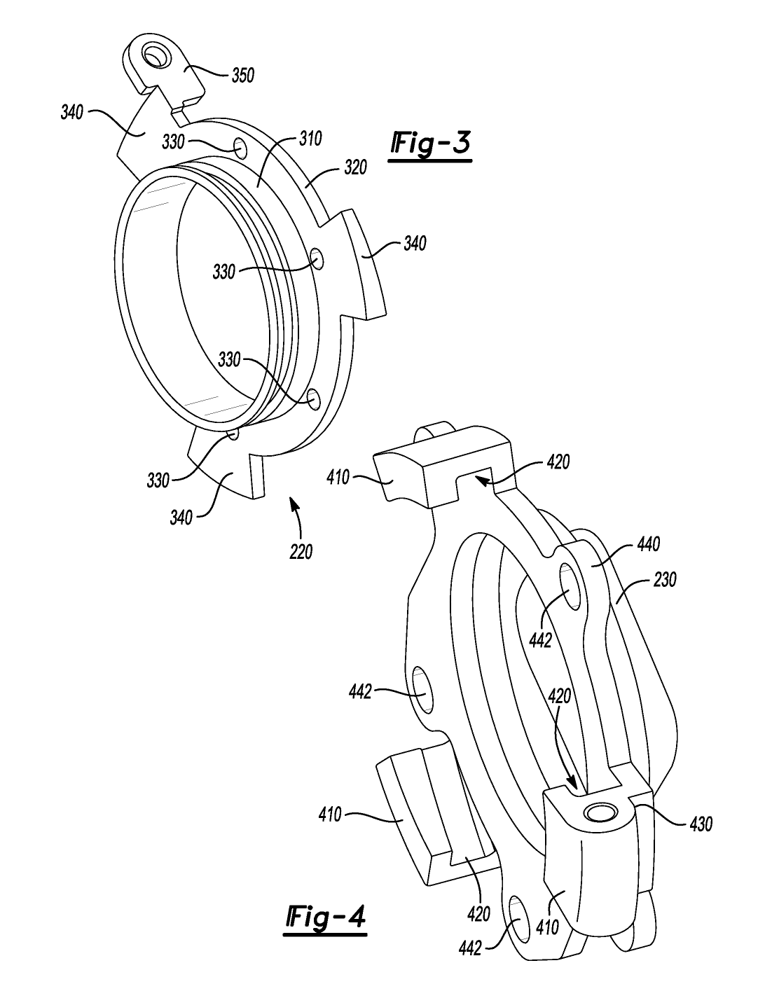

As can be understood, the first connector 220 may include at least one means for connecting or coupling the first connector 220 with the second connector 230. These means are explained with reference to FIG. 3. FIG. 3 illustrates a perspective view of the first connector 220 according to an embodiment of the present subject matter. As seen in FIG. 3, the first connector 220 may comprise a first portion 310 and a second portion 320. The outer periphery of the first portion 310, hereinafter referred to as a neck, defines a circle. The second portion 320, hereinafter referred to as a flange 320, is contiguous with the neck 310 and extends radially outward in a direction perpendicular to the axis of the first connector 220.

In an embodiment, the integration of the first connector 220 with the first duct 210 may be achieved by over-molding the flexible material of the first duct 210 onto the first connector 220. In case where the duct material used for molding onto the first connector 220 is not chemically compatible with the material of the first connector 220, there may not be sufficient chemical adhesion between the duct material and the first connector 220. This limitation may be overcome by providing adequate strength to the joining interface to the portion of the first connector 220 enclosed in the first duct 210. This strength may be achieved by incorporating at least one axial cut-out 330 in the first connector 220 through which the duct material flows and fixes itself around the first connector 220. The cut-outs 330 may be provided on the flange 320. The cut-outs 330 may be distributed around the periphery of the flange 320. In an example, the axial cut-out 330 may be an aperture.

In an example, in order to further enhance the adhesion between the first connector 220 and the duct material being molded onto the first connector 220, indentations may be provided on the flange 320 of the first connector 220. These indentations will increase the surface area of contact between the duct material and the first connector 220, thereby resulting in the enhancement of the adhesion.

The neck 310 of the first connector 220 may have a circular outer surface. Since the neck 310 and the flange 320 are contiguous, the internal diameter of the neck 310 may be the same as the internal diameter of the flange 320, and the internal diameters of the neck 310 and flange 320 may be substantially the same as the internal diameter of the duct 210. In another example, the internal diameters of the neck 310 and the flange 320 may be larger than the internal diameter of the first duct 210.

In one example, the first connector 220 may be manufactured without having a neck (not shown in the FIG. 2C). In such a case the radial grove 250 is not provided. Since there is no radial grove 250, the manufacture of the first connector 220 is simplified. Further, the first connector 220 may have a reduced stack-up length. In this example, the sealing may be achieved by the axial seal 270 as shown in FIG. 2C.

The flange 320 of the first connector 220 may further include at least one bayonet tab 340. The bayonet tabs 340 may extend radially outward. The bayonet tabs 340 may be disposed on the outer periphery of the flange 320 of the first connector 220. The bayonet tabs 340 are adapted to engage with the second connector 230. The number of bayonet tabs 340 may vary as per the application requirements.

In an embodiment, at least one bayonet tab 340 includes a fastening flange 350 adapted to receive a screw, bolt, or other types of fastening means, to securely engage the fastening flange 350 with the second connector 230, thereby securing the detachable coupling between the first connector 220 and the second connector 230 such that the first connector 220 and the second connector 230 are held firmly.

It may be understood that the first connector 220 may be manufactured as a separate component which can subsequently be integrated with the first duct 210. The duct material for the first duct 210 may be a rigid material or a flexible material. The integration of the first connector 220 with the first duct 210 may be achieved by molding, bonding, fastening, or clamping. Yet other methods for integrating the first connector 220 with the first duct 210 are within the scope of the present subject matter. In another example, when the first duct 210 is manufactured from a rigid material, the first connector 220 is formed while molding the first duct 210 and therefore there is no need to manufacture the first connector 220 separately or independent of the first duct 210.

FIG. 4 illustrates the second connector 230 of the duct assembly 200. The second connector 230 comprises at least one bayonet receiver 410 having an inwardly-oriented bayonet slot 420, a fastening bracket 430, and flange 440. In an example, the flange 440 enables the mounting of the second connector 230 onto the second component of the system, for example by means of mounting holes 442. The bayonet slots 420 are adapted to receive the bayonet tabs 340 of the first connector 220. To form a detachable coupling, the first connector 220 and the second connector 230 are brought together with the bayonet tabs 340 in alignment with the circumferential gaps separating the respective bayonet receivers 410. Once aligned, the first connector 220 and the second connector 230 are rotated with respect to each other, thereby engaging the bayonet tabs 340 of the first connector 220 with the respective bayonet receivers 410 of the second connector 230. Once engaged, any one of the various fastening or connecting means is used to fasten the first connector 220 and the second connector 230.

In the disclosed example, the connector having bayonet tabs 340 is a male connector, and the connector having bayonet receivers 410 is a female connector. In another example (not shown), the first connector 220 may be a female connector and the second connector 230 may be a male connector. In the example where the second connector 230 is the male connector, bayonet tabs similar to those identified as 340 in FIG. 3 may instead be disposed on the periphery of the flange 440 of the second connector 230. In another example, each of the first connector 220 and the second connector 230 may include at least one bayonet tab and at least one bayonet receiver disposed on the respective periphery of each of the connectors. The at least one bayonet tab and the at least one bayonet receiver on the first connector 220 may be adapted to engage with corresponding at least one bayonet receiver and the at least one bayonet tab on the second connector 230.

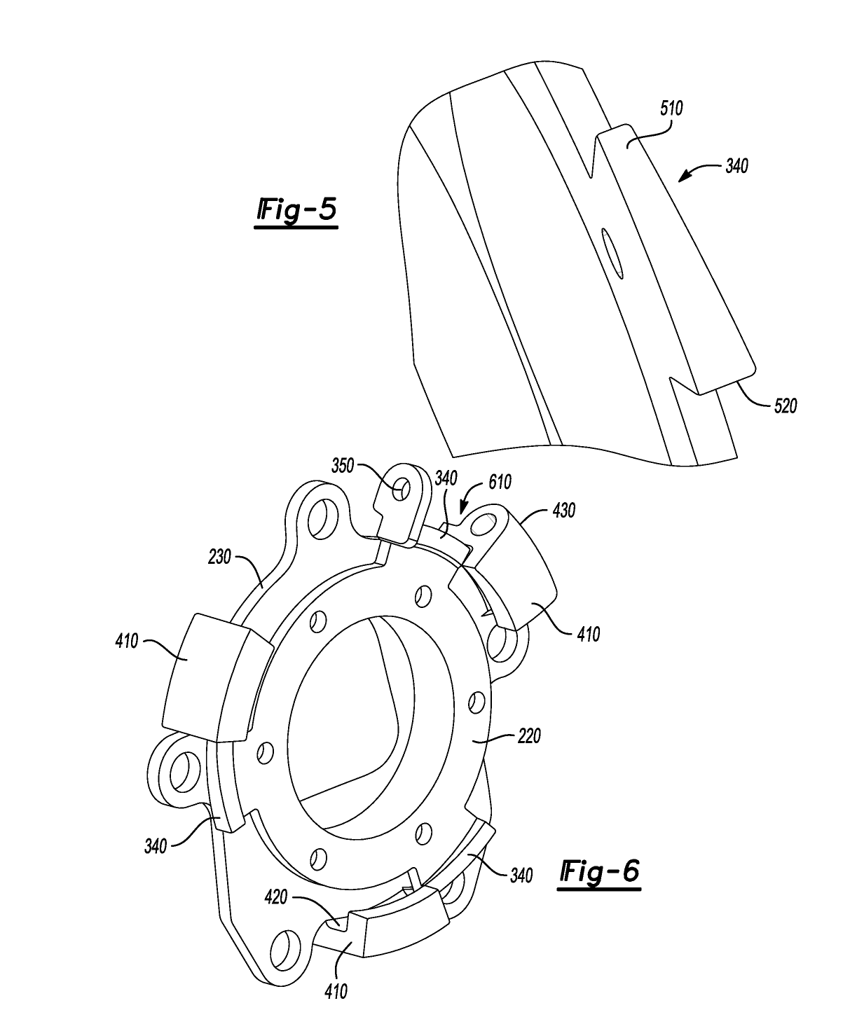

The operation of the bayonet mechanism is explained with reference to FIG. 5 and FIG. 6. In this embodiment, the bayonet tabs 340 have a ramped or tapered profile. As illustrated in FIG. 5, one end of the bayonet tab 340 has a thin profile 510. Due to the tapered profile, the thickness of the bayonet tab 340 gradually increases such that the other end of the bayonet tab 340 has a thick profile 520. The tapered profile of the bayonet tab 340 facilitates the advancement of the radial seal 260 and the axial seal 270 of the first connector 220 into sealing contact with the second connector 230 when the first connector 220 is rotated into engagement with the second connector 230. The provision of the tapered profile of the bayonet tab 340 facilitates the rotation of the first connector 220 into the second connector 230 such that less insertion force is required for advancing the first connector 220 into the second connector 230. The rotational motion of the first connector 220 advances the radial seal 260 and the axial seal 270 into the second connector 230, thereby optimizing the sealing mechanism between the first connector 220 and the second connector 230. In another example, the bayonet tabs 340 may have a uniform thickness.

FIG. 6 illustrates the first connector 220 (without the first duct attached thereto) in a pre-engaged position relative to the second connector 230. The bayonet mechanism of the first embodiment comprises the first connector 220 and the second connector 230. The first connector 220 is adapted to be rotated into the second connector 230. In doing so, the bayonet tabs 340 on the first connector 220 are made to engage with the respective bayonet receivers 410 on the second connector 230. The end of the bayonet tab 340 with the thin profile 510 facilitates easy entrance of the bayonet tab 340 into the bayonet slot 420 of each receiver 410, and as the rotation proceeds and the thickness of the bayonet tab 340 engaging the slot 420 increases, the engagement becomes tighter and more secure. When the fastening flange 350 touches the fastening bracket 430, it acts as a stopper, and thus limits the rotation of the first connector 220 relative to the second connector 230. The fastening bracket 430 and the fastening flange 350 together form a fastening mechanism 610 adapted to receive a screw or bolt to secure the detachable coupling between the first connector 220 and the second connector 230.

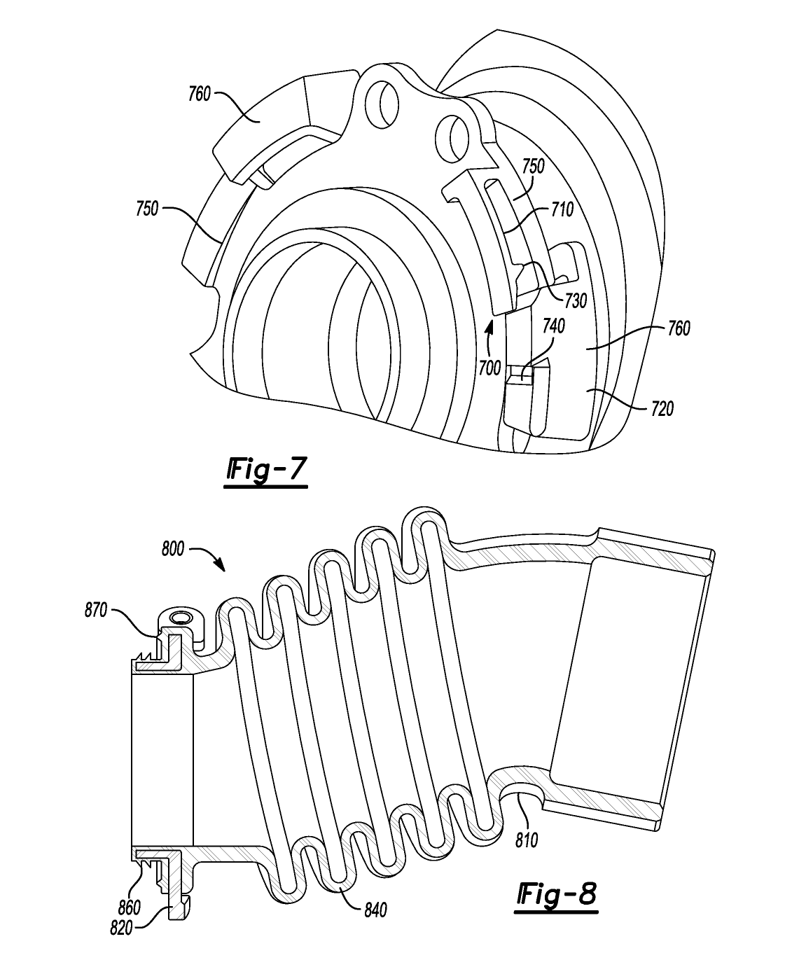

In another example shown in FIG. 7, the first and second connectors are secured to one another by a fastener clip assembly 700. The fastener clip assembly 700 comprises a male component 710 associated with one or more of the bayonet tabs 750 and a female component 720 associated with one or more of the bayonet receivers 760. The male component 710 may comprise a protrusion 730, and the female component 720 may comprise at least one slot 740 formed in a bayonet receiver 760. It is, of course, alternatively possible for a slot to be formed in the male component 710 to receive a protrusion on the bayonet receiver 760. In another example, the male component 710 of the fastener clip assembly may comprise at least one bayonet receiver 760 having a protrusion 730, and the female component 720 may comprise at least one bayonet tab 750 having a slot 740. In this example, the bayonet tabs 750 may be disposed on the periphery of the second connector, and the bayonet receivers 760 may be disposed on the periphery of the first connector. The engagement of the protrusion 730 of the male component 710 and the slot 740 of the female component 720 provides a secure engagement between the bayonet tabs 750 and the bayonet receivers 760, so that the second connector is held in a fixed position inside the first connector.

According to another embodiment of the present subject matter, a duct assembly 800 is illustrated in FIG. 8. In this embodiment, the first connector 820 is enclosed by the first duct 810, and the radial groove 250 and seal ring 260 of the FIG. 2C embodiment is replaced by an integrated radial seal 860 incorporated in the first duct 810. The integrated radial seal 860 is shown to comprise two projecting ribs that are generally triangular in profile, but the radial seal may be of any cross section, and the number of the integrated radial seal 860 to be incorporated in the first duct 810 will depend on the application requirements. As such, the manufacturing of the first connector 820 is simplified since no grooving operation is needed to be performed on the first connector 820. A separate radial seal component in the form of an O-ring, D-ring, X-ring, and the like may be absent in this example. As the number of components is reduced, the complexity in manufacturing the duct assembly 800 as per the present example is greatly reduced.

The present example of the duct assembly 800 may also include an axial seal 870. The axial seal 870 may be absent in other examples where the axial sealing is not required.

The duct assembly 800 may be manufactured from a flexible material for applications where the duct assembly 800 may have to withstand vibrations. Furthermore, convolutes 840 may also be incorporated in the duct assembly 800 to provide flexibility to the duct assembly 800. In another example, the duct assembly 800 may be manufactured from a rigid material.

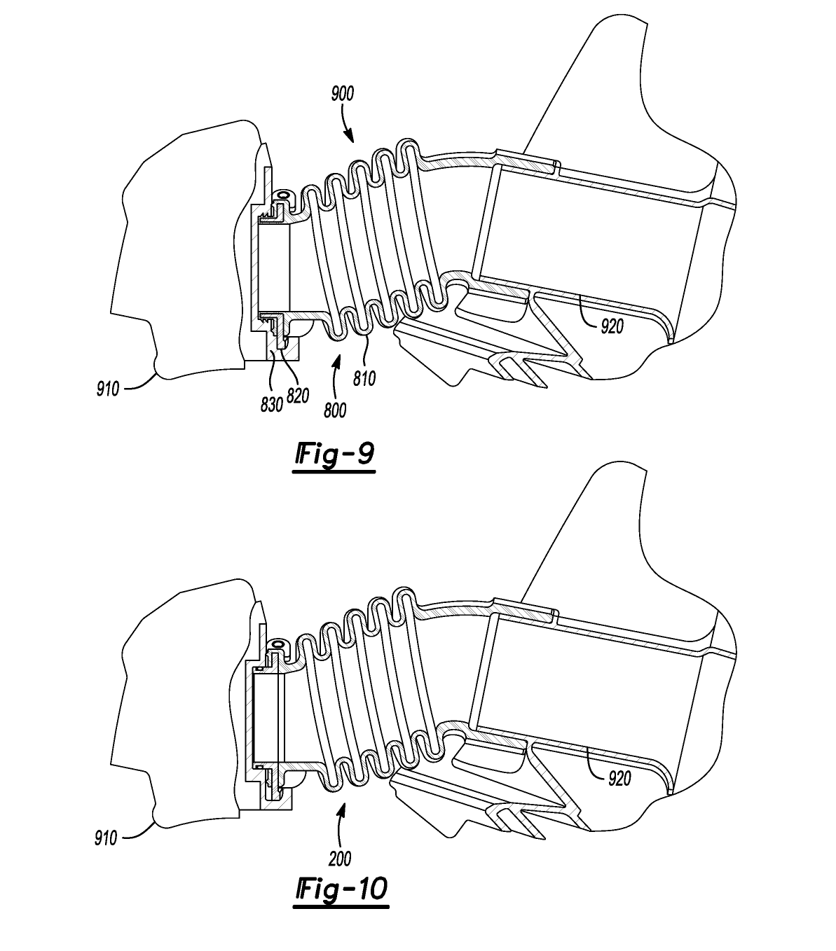

As shown in FIG. 9, the duct assembly 800 may be implemented as part of a duct system 900 to connect a first component and a second component. In an example, the first component of the duct system 900 may be an exhaust gas recirculation (EGR) valve 910 of a vehicle and the second component of the duct system 900 may be an air-filter housing 920 of the vehicle.

As can be seen in FIG. 9, the second connector 830 may be directly mounted onto the second component, i.e., the EGR valve 910, such that the first duct 810 is directly terminated into the EGR valve 910. In another example, the duct system 900 may include a second duct (not shown) which has a first end and a second end. The second connector 830 maybe integrally connected to the second duct at the first end of the second duct and the second end of the second duct may be mounted onto the second component of the duct system 900.

As can be seen from FIG. 9, the duct assembly 800 comprises the first duct 810 with the integrated first connector 820, and a second connector 830 directly mounted onto the second component, i.e., EGR valve 910. As the number of components is reduced, the complexity in the construction of the duct assembly 800 is reduced as compared to the prior art duct assembly.

FIG. 10 shows the duct assembly 200, including a radial groove 250 separate radial seal 260 (features of which have been explained in detail with reference to FIGS. 2A-C and 3) installed in the duct system 1000..

As those of ordinary skill in the art will appreciate, various features of the various examples disclosed and described with reference to the Figures maybe combined with one or more other features disclosed in one or more other drawings to develop alternative embodiments that are not explicitly described herein. However, such alternative embodiments involving combinations and modifications of the various features described herein are well within the scope of this invention.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. Apparatus comprising:
a duct made of a first material; and
a connector made of a second material more rigid than the first material, surrounding an opening of the duct and comprising:
a neck projecting axially relative to the opening;
a flange extending radially outward from the neck and at least partially embedded within a wall of the duct; and
a bayonet tab extending radially outward from the flange and disposed outside the wall.

2. The apparatus of claim 1 wherein a portion of the duct wall enclosing the flange comprises an axially-extending seal configured to contact a mating connector.

3. The apparatus of claim 1, wherein the flange and the neck are embedded within the wall.

4. The apparatus of claim 3, wherein a portion of the duct wall enclosing the neck comprises a radially-extending seal configured to contact a mating connector.

5. The apparatus of claim 1, wherein the bayonet tab comprises ramped surfaces configured to engage a feature of a mating connector.

6. The apparatus of claim 1, wherein the bayonet tab comprises a locking feature configured to engage a corresponding feature of a mating connector.

7. Apparatus comprising:
a flexible duct; and
a rigid connector joined to an end of the duct and comprising: a neck projecting axially relative to a duct opening; a flange extending radially outward from the neck and at least partially surrounded by a wall of the duct; and a bayonet tab extending radially outward from the flange and disposed outside the wall.

8. The apparatus of claim 7 wherein a portion of the duct wall surrounding the flange comprises an axially-extending seal configured to contact a mating connector.

9. The apparatus of claim 7, wherein the flange and the neck are surrounded by the wall.

10. The apparatus of claim 9, wherein a portion of the duct wall surrounding the neck comprises a radially-extending seal configured to contact a mating connector.

11. The apparatus of claim 7, wherein the bayonet tab comprises ramped surfaces configured to engage a corresponding feature of a mating connector.

12. The apparatus of claim 7, wherein the bayonet tab comprises a locking feature configured to engage a corresponding feature of a mating connector.

13. Apparatus comprising:
a connector comprising an annular flange and a plurality of radially-extending bayonet tabs configured to engage a corresponding feature of a mating connector; and
a duct over-molded onto the connector to at least partially surround the flange, the bayonet tabs extending radially outward through a wall of the duct and located outside of the wall.

14. The apparatus of claim 13 wherein a portion of the duct wall surrounding the flange comprises an axially-extending seal configured to contact the mating connector.

15. The apparatus of claim 13, wherein the connector further comprises:
a neck projecting axially relative to the flange and configured to extend inside of the mating connector.

16. The apparatus of claim 15, wherein the wall completely surrounds the flange and the neck.

17. The apparatus of claim 16, wherein a portion of the wall enclosing the neck comprises a radially-extending seal configured to contact the mating component.

18. The apparatus of claim 13, wherein at least one of the bayonet tabs comprises a ramped surface configured to engage the corresponding feature of the mating connector.

19. The apparatus of claim 13, wherein at least one of the bayonet tabs comprises a locking feature configured to engage the corresponding feature of the mating connector.
